(19) United States
(12) Patent Application Publication
(10) Pub. No.: US 2024/0265424 A1
(43) Pub. Date: Aug. 8, 2024

(54) RANKING SEARCH RESULTS BASED ON INCENTIVE, ESG AND/OR DIVERSITY DATA

(71) Applicant: Prodigo Solutions Inc., Cranberry Township, PA (US)

(72) Inventors: Marlin Dean Doner, Gibsonia, PA (US); Dermot Kelly Pope, Gibsonia, PA (US); Aaron Mark Manuel, Cranberry Township, PA (US)

(73) Assignee: Prodigo Solutions Inc., Cranberry Township, PA (US)

(21) Appl. No.: 18/634,592

(22) Filed: Apr. 12, 2024

Related U.S. Application Data
(63) Continuation-in-part of application No. 15/373,696, filed on Dec. 9, 2016.
(60) Provisional application No. 62/265,066, filed on Dec. 9, 2015.
(60) Provisional application No. 62/431,611, filed on Dec. 8, 2016.
(60) Provisional application No. 62/275,397, filed on Jan. 6, 2016.

(51) Int. Cl. G06Q 30/0251

(52) U.S. Cl. CPC G06Q 30/0256; G06Q 30/0253

(57) ABSTRACT

The method comprises receiving a search query for one or more products; determining a query result set of a plurality of result products, in response to the search query; determining a subset of the plurality of result products that satisfy at least one of environmental, social, governance (ESG) factors or diversity factors; ranking the subset of the plurality of result products to create a ranked query result, based at least in part on a weighting of the at least one of the ESG factors or the diversity factors; and providing the ranked query result set to the user.

### CROSS-REFERENCE TO RELATED APPLICATIONS

This application is a continuation-in-part of, and claims priority to and the benefit of, U.S. Ser. No. 15/373,696, filed on Dec. 9, 2016 and entitled “Systems And Methods For Ranking Search Results Based On Item Price Incentive Data.” The '696 application claims priority to U.S. Provisional Application No. 62/265,066, filed Dec. 9, 2015 and entitled “Systems And Methods For Ranking Search Results Based On Rebate Data;” and U.S. Provisional Application No. 62/431,611, filed Dec. 8, 2016 and entitled “Systems And Methods For Ranking Search Results Based On Item Price Incentive Data;” and U.S. Provisional Application No. 62/275,397 filed Jan. 6, 2016 and entitled “Systems And Methods For Ranking Search Results Based On Rebate Data.” The entire contents of all of these applications are hereby incorporated by reference in their entirety for all purposes.

### FIELD

The present disclosure generally relates to the field of online product procurement systems. The present disclosure relates more specifically to systems and methods of receiving a search query for one or more products from the procurement system, determining a result set that is responsive to the query, identifying one or more products of the result set that are associated with structured price incentives such as: rebates, administrative fees paid by Group Purchasing Organizations (GPOs), volume based prices, and purchase commitment based price tiers; then ranking the result set for the user based on the structured price incentives.

### BACKGROUND

Many organizations utilize searchable electronic catalogs to present customers with goods and/or services from supply chain-approved vendors of the organization. To support purchasing functionality, these catalogs may be consolidated into a marketplace whereby requesters view product details prior to purchasing, and purchase products in a single interface. In some instances, organizations may have price incentives negotiated into price agreements with one or more suppliers. For example, an organization may receive a discount on a product after a certain number of the product has been purchased, for purchases above a growth threshold, and/or for purchase activity above a threshold value.

### SUMMARY

For an organization with price agreements in place with suppliers that contain price incentive terms, it is of importance to the organization that, if possible, users of the online product procurement system maximize the use of price incentives to save the organization money. Therefore, the organization has an interest in ensuring that, if more than one product is responsive to a search request of a user (the “purchaser”), the purchaser is presented with items that may fulfill terms of the price incentive more prominently than other products. For example, a rebate may not activate until 10,000 of Product A has been purchased. Therefore, if 9,500 of Product A has already been purchased by the organization, the organization has an interest in offering Product A more prominently than, for example, Product B, that is not part of a price incentive structure (assuming Product A and B are suitable substitutes for each other).

Applicants have thus appreciated that there is a need for a product procurement system with automated methods for ranking products that are responsive to a search query based on price incentives associated with the products.

Systems and methods are provided for ranking products that are responsive to a search query based on price incentives associated with the products. The search queries may be natural language strings that are utilized to identify one or more products. Price incentives associated with one or more of the products, and scores may be assigned to the products based on one or more factors, including associated price incentives. The resulting ranked products may then be provided to the user for selection.

In one exemplary embodiment, a method of displaying on an electronic display price incentive-influenced query results comprises: storing on one or more data storage devices a purchase activity database, a rebate database, a price agreement database with item prices and price incentive terms, a substitute product database, a marketplace database, user I/O logic for receiving user query data and sending signals to display query results on a computer display, and price incentive influenced relevance score logic; receiving user query data in a window of a computer user input, such as a web browser; with one or more processors, retrieving purchase history data relating to the user query data from the purchase activity database; with one or more processors, retrieving price incentive data relating to the user query data from the rebate database and price agreement database; with one or more processors, retrieving substitute product data relating to the user query data from the substitute product database; determining automatically, with one or more processors using the price incentive influenced search relevance score logic, a price incentive-influenced search relevance score for candidate products using at least some of the retrieved purchase history data, at least some of the retrieved rebate data, the price incentive data and substitute product data; automatically with one or more processors, ordering candidate products consistent with their price incentive-influenced search relevance score to generate the price incentive-influenced query results; and automatically providing at least some of the price incentive-influenced query results to an electronic display, the price incentive-influenced query results being configured to display a web page on the electronic display. In some exemplary embodiments, the price incentive influenced search relevance score logic comprises search relevance score logic, price incentive threshold distance logic, and other price incentive influenced search relevance score logic; further comprising storing on the one or more data storage devices the search relevance score logic and the price incentive threshold distance logic; and wherein the step of determining automatically the price incentive-influenced search relevance score comprises the step of determining automatically the price incentive-influenced search relevance score for candidate products comprises determining automatically, with one or more processors using the search relevance score logic, the price incentive threshold distance logic, and the other price incentive influenced search relevance score logic, a price incentive-influenced search relevance score for candidate products using at least some of the retrieved purchase history data, at least some of the retrieved price incentive data, price agreement data and substitute product data; and wherein the candidate products ordered using the price incentive-influenced search relevance score are ordered differently than the candidate products would have been if ordered only using a non-price incentive influenced relevance score calculated using the search relevance score logic but not the price incentive threshold distance logic.

In another exemplary embodiment, a computer system is preprogrammed to implement a method of displaying on an electronic display price incentive-influenced query results comprising: storing on one or more data storage devices a purchase activity database, a rebate database, a price agreement database, a substitute product database, a marketplace database, user I/O logic for receiving user query data and sending signals to display query results on a computer display, and price incentive influenced relevance score logic; receiving user query data in a window of a computer user input, such as a web browser; with one or more processors, retrieving purchase history data relating to the user query data from the purchase activity database; with one or more processors, retrieving rebate data relating to the user query data from the rebate database; with one or more processors, retrieving price incentive data from the price agreement database; with one or more processors, retrieving substitute product data relating to the user query data from the substitute product database; determining automatically, with one or more processors using the price incentive influenced search relevance score logic, a price incentive-influenced search relevance score for candidate products using at least some of the retrieved purchase history data, at least some of the retrieved rebate data, price incentive data and substitute product data; automatically with one or more processors, ordering candidate products consistent with their price incentive-influenced search relevance score to generate the price incentive-influenced query results; and automatically providing at least some of the price incentive-influenced query results to an electronic display, the price incentive-influenced query results being configured to display a web page on the electronic display.

In yet another exemplary embodiment, a data storage device is pre-programmed with code causing a processor to display on an electronic display price incentive-influenced query results by performing a method that comprises: storing on one or more data storage devices a purchase activity database, a rebate database, a price agreement database, a substitute product database, a marketplace database, user I/O logic for receiving user query data and sending signals to display query results on a computer display, and price incentive influenced relevance score logic; receiving user query data in a window of a computer user input, such as a web browser; with one or more processors, retrieving purchase history data relating to the user query data from the purchase activity database; with one or more processors, retrieving rebate data relating to the user query data from the rebate database; with one or more processors, retrieving price incentive data from the price agreement database; with one or more processors, retrieving substitute product data relating to the user query data from the substitute product database; determining automatically, with one or more processors using the price incentive influenced search relevance score logic, a price incentive-influenced search relevance score for candidate products using at least some of the retrieved purchase history data, at least some of the retrieved rebate data, price incentive data and substitute product data; automatically with one or more processors, ordering candidate products consistent with their price incentive-influenced search relevance score to generate the price incentive-influenced query results; and automatically providing at least some of the price incentive-influenced query results to an electronic display, the price incentive-influenced query results being configured to display a web page on the electronic display.

In still another exemplary embodiment, a method of displaying on an electronic display rebate-influenced query results comprises: storing on one or more data storage devices a purchase activity database, a rebate database, a substitute product database, a marketplace database, user I/O logic for receiving user query data and sending signals to display query results on a computer display, and rebate influenced relevance score logic; receiving user query data in a window of a computer user input, such as a web browser; with one or more processors, retrieving purchase history data relating to the user query data from the purchase activity database; with one or more processors, retrieving rebate data relating to the user query data from the rebate database; with one or more processors, retrieving substitute product data relating to the user query data from the substitute product database; determining automatically, with one or more processors using the rebate influenced search relevance score logic, a rebate-influenced search relevance score for candidate products using at least some of the retrieved purchase history data, at least some of the retrieved rebate data, and rebate data substitute product data; automatically with one or more processors, ordering candidate products consistent with their rebate-influenced search relevance score to generate the rebate-influenced query results; and automatically providing at least some of the rebate-influenced query results to an electronic display, the rebate-influenced query results being configured to display a web page on the electronic display. In some exemplary embodiments, the rebate influenced search relevance score logic comprises search relevance score logic, rebate threshold distance logic, and other rebate influenced search relevance score logic; further comprising storing on the one or more data storage devices the search relevance score logic and the rebate threshold distance logic; and wherein the step of determining automatically the rebate-influenced search relevance score comprises the step of determining automatically the rebate-influenced search relevance score for candidate products comprises determining automatically, with one or more processors using the search relevance score logic, the rebate threshold distance logic, and the other rebate influenced search relevance score logic, a rebate-influenced search relevance score for candidate products using at least some of the retrieved purchase history data, at least some of the retrieved rebate data, and rebate data substitute product data; and wherein the candidate products ordered using the rebate-influenced search relevance score are ordered differently than the candidate products would have been if ordered only using a non-rebate influenced relevance score calculated using the search relevance score logic but not the rebate threshold distance logic.

In yet still another exemplary embodiment, a computer system is preprogrammed to implement a method of displaying on an electronic display rebate-influenced query results comprising: storing on one or more data storage devices a purchase activity database, a rebate database, a substitute product database, a marketplace database, user I/O logic for receiving user query data and sending signals to display query results on a computer display, and rebate influenced relevance score logic; receiving user query data in a window of a computer user input, such as a web browser; with one or more processors, retrieving purchase history data relating to the user query data from the purchase activity database; with one or more processors, retrieving rebate data relating to the user query data from the rebate database; with one or more processors, retrieving substitute product data relating to the user query data from the substitute product database; determining automatically, with one or more processors using the rebate influenced search relevance score logic, a rebate-influenced search relevance score for candidate products using at least some of the retrieved purchase history data, at least some of the retrieved rebate data, and rebate data substitute product data; automatically with one or more processors, ordering candidate products consistent with their rebate-influenced search relevance score to generate the rebate-influenced query results; and automatically providing at least some of the rebate-influenced query results to an electronic display, the rebate-influenced query results being configured to display a web page on the electronic display.

In yet another exemplary embodiment, a data storage device is pre-programmed with code causing a processor to display on an electronic display rebate-influenced query results by performing a method that comprises: storing on one or more data storage devices a purchase activity database, a rebate database, a substitute product database, a marketplace database, user I/O logic for receiving user query data and sending signals to display query results on a computer display, and rebate influenced relevance score logic; receiving user query data in a window of a computer user input, such as a web browser; with one or more processors, retrieving purchase history data relating to the user query data from the purchase activity database; with one or more processors, retrieving rebate data relating to the user query data from the rebate database; with one or more processors, retrieving substitute product data relating to the user query data from the substitute product database; determining automatically, with one or more processors using the rebate influenced search relevance score logic, a rebate-influenced search relevance score for candidate products using at least some of the retrieved purchase history data, at least some of the retrieved rebate data, and rebate data substitute product data; automatically with one or more processors, ordering candidate products consistent with their rebate-influenced search relevance score to generate the rebate-influenced query results; and automatically providing at least some of the rebate-influenced query results to an electronic display, the rebate-influenced query results being configured to display a web page on the electronic display.

In various embodiments, the system may further implement a method comprising receiving, by one or more processors, a search query for one or more products; determining, by the one or more processors, a query result set of a plurality of result products, in response to the search query; determining, by the one or more processors, a subset of the plurality of result products that satisfy at least one of environmental, social, governance (ESG) factors or diversity factors; ranking, by the one or more processors, the subset of the plurality of result products to create a ranked query result, based at least in part on a weighting of the at least one of the ESG factors or the diversity factors; and providing, by the one or more processors, the ranked query result set to the user.

In various embodiments, the method may further comprise determining, by the one or more processors, the weighting of the at least one of the ESG factors or the diversity factors. The method may further comprise associating, by the one or more processors, each of the plurality of result products with at least one of the ESG factors, the diversity factors or the price incentive factors. The method may further comprise replacing, by the one or more processors, one or more of the result products in the subset of the plurality of result products with one or more substitute products. The method may further comprise receiving, by the one or more processors, from a user at least one of the ESG factors or the diversity factors.

The ranking the subset of the plurality of result products to create the ranked query result may be further based at least in part on a multi-factor weighting of at least one of the ESG factors, the diversity factors or the price incentive factors. The determining the subset of the plurality of result products that satisfy at least one of the ESG factors or the diversity factors may include satisfying at least one of a threshold of the ESG factors or a threshold of the diversity factors. The ESG factors may include at least one of environmental factors, social factors or governance factors. The determining the subset of the plurality of result products further may include determining the subset of the plurality of result products that satisfy price incentive factors. The price incentive factors may include at least one of a total to fulfill the price incentive or a price incentive amount. The price incentive factors may comprise data that alters a purchase price of a product based on at least one of a tier, a volume, a rebate or an administrative fee.

The ranking may be further based on price incentive factors, and wherein the price incentive factors may be based on a number of the one or more products that have been purchased to date, a value of the one or more products that have been purchased to date or a total to fulfill a price incentive threshold value for the one or more products. The ranking may be further based on price incentive factors, and wherein a first price incentive eligible product may be more indicative of importance than a second price incentive eligible product when the number of the first price incentive eligible products sold is closer to fulfillment than the second price incentive eligible product. The ranking may be further based on price incentive factors, and wherein a ranking of a price incentive eligible product may be more indicative of importance than a second product of the query result when the second product is not associated with a price incentive structure. The ranking may be further based on price incentive factors, and wherein the price incentive factors may include a tiered price incentive structure, wherein the tiered price incentive structure includes two or more tiers, and wherein each of the tiers includes a total to fulfill the tier and a tier price incentive amount. The ranking may be further based on price incentive factors, and wherein the ranking may be associated with a tiered price incentive that is determined based on an amount of the price incentive eligible product to be sold to satisfy a tier. The ranking may be further based on price incentive factors, and wherein the ranking may be based on at least one of a number or value of the products that have been purchased to date and total to fulfill the price incentive threshold value and further wherein at least one of the price incentive structures is a tiered price incentive structure, wherein the tiered price incentive structure includes two or more tiers, and wherein each of the tiers may include a total to fulfill the tier and a tier price incentive amount. The ranking may be further based on a fulfillment score, wherein the fulfillment score may be determined based on a price incentive structure for one or more of the result products. The method may further comprise receiving, by the one or more processors, from a user at least one of the ESG factors or the diversity factors.

### BRIEF DESCRIPTION OF THE DRAWINGS

The accompanying drawings, wherein like numerals depict like elements, illustrate exemplary embodiments of the present disclosure, and together with the description, serve to explain the principles of the disclosure. In the drawings:

FIG. 1 is a block diagram of an example environment in which query results may be ranked and provided based on price incentives associated with responsive products, in accordance with various embodiments.

FIG. 2 is an illustration of an interface that may be utilized to provide search results, in accordance with various embodiments.

FIG. 3 is an illustration of an interface that may be utilized by a user to provide rebate structures, in accordance with various embodiments.

FIG. 4 is a flowchart illustrating an example method of providing query results that are ranked based on received price incentive structures, in accordance with various embodiments.

FIG. 5 is a flowchart illustrating an example method of providing query results that are ranked based on fulfillment scores associated with one or more of the search results, in accordance with various embodiments.

FIG. 6 illustrates a block diagram of an example computing device, in accordance with various embodiments.

FIG. 7 illustrates a process flow that may be utilized for an online product procurement system, in accordance with various embodiments.

FIG. 8 illustrates a process flow chart that may be utilized for an online product procurement system search engine, in accordance with various embodiments.

FIGS. 9A and 9B are illustrations of interfaces that may be utilized to provide a user with search results ordered by existing price incentives, in accordance with various embodiments.

FIG. 10 is an illustration of an interface that may be utilized to provide a user with price incentive information at the point of purchase, in accordance with various embodiments.

FIG. 11 is a schematic flow diagram showing various inputs and outputs for an exemplary price incentive-influenced search engine, in accordance with various embodiments.

FIG. 12 is a schematic diagram showing an exemplary memory of an exemplary Memory of Price Incentive Influenced Search Engine implemented on a computer system, in accordance with various embodiments.

FIG. 13 is a flowchart illustrating an example method of providing query results that are ranked based on the weighting of ESG factors or the diversity factors associated with one or more of the search results, in accordance with various embodiments.

### DETAILED DESCRIPTION

This Detailed Description merely describes exemplary embodiments of the invention and is not intended to limit the scope of the claims in any way. Indeed, the invention as claimed is broader than the exemplary embodiments, and the terms used in the claims have their full ordinary meaning, unless an express definition is provided herein.

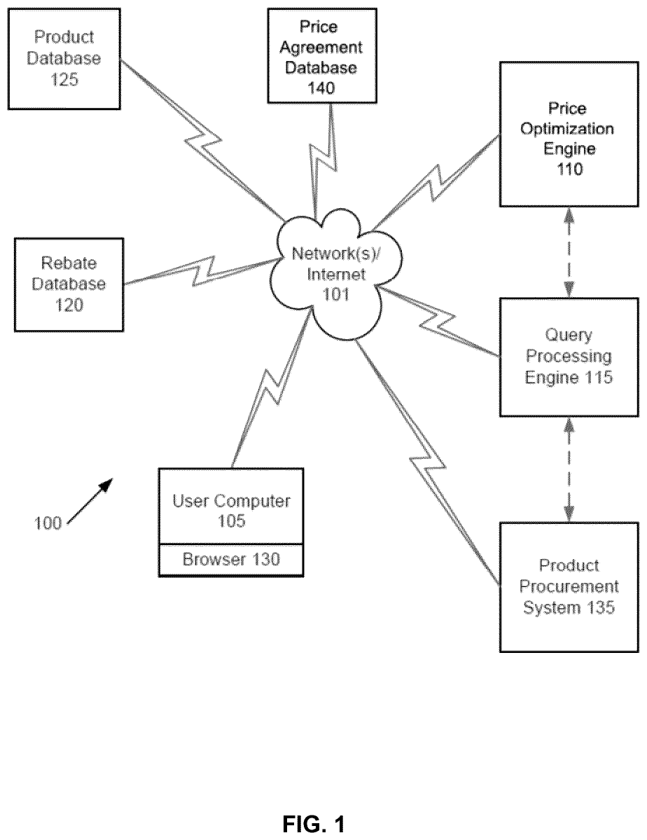

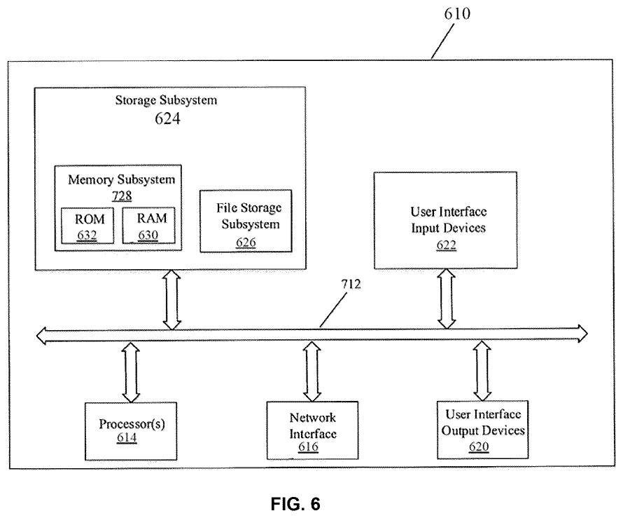

Referring to FIG. 1, a block diagram of an exemplary system 100 is provided. The system 100 includes a communication network 101, one or more user computer devices 105, a product procurement system 135 with a price optimization engine 110 and a query processing engine 115, a rebate database 120, a product database 125, and a price agreement database 140. In some implementations, the communication network 101 may include the Internet, one or more intranets, and/or one or more bus subsystems. The communication network 101 may optionally utilize one or more standard communications technologies, protocols, and/or inter-process communication techniques. One or more user computer devices 105 may be in communication with each other and/or with one or more components illustrated in FIG. 1 via communication network 101. In some exemplary embodiments, one or more of the components illustrated in FIG. 1 may share one or more characteristics with the exemplary computing device illustrated in FIG. 6 and/or one or more of the components illustrated in FIG. 1 may be executing on a computing device that shares one or more characteristics with the computing device illustrated in FIG. 6. A browser 130 executing on user device 105 may send and/or receive communication from one or more other components illustrated in FIG. 1. For example, a user may utilize browser 130 to send a search query to query processing engine 115. Also, for example, query processing engine 115 may send a result set of products to the user via browser 130.

In exemplary embodiments, product procurement system 135 includes logic for providing users with an interface for communicating with one or more components. For example, a user may be provided with a user interface via browser 130 on user device 105 by one or more components of product procurement system 135. In some exemplary embodiments, the interface provided by product procurement system 135 may allow for a user to provide information related to the structure of a price incentive. In some exemplary embodiments, the interface provided by product procurement system 135 may allow for a user to search for one or more products in product database 125. Additionally or alternatively, an interface provided by product procurement system 135 may allow for a user to select and/or purchase one or more products from product database 125.

In exemplary embodiments, rebate database 120 includes information related to rebates available on one or more products that a user may select and/or purchase. Of particular interest is information relating to structured rebates with values that change over time, e.g., tiered rebates. In some exemplary embodiments, rebate database 120 includes data for locally hosted products stored in data storage devices of one or more local computers.

In exemplary embodiments, product database 125 includes information related to one or more products that a user may select and/or purchase. For example, product database 125 may include a selection of medical supplies and include information related to the medical supplies. In some exemplary embodiments, products in product database 125 may include: a unique product identifier, Product Description(s), Product Attributes, Product Dimensions, Product Count, Unit of Measure, Manufacturer Name, Manufacturer Part #, UPC #, Global Trade Identifier [GTIN], United Nations Standard Products and Services Code [UNSPSC], Product Image(s), Product/Usage Video(s), Latex Indicator, Sterile Indicator, MRI Safe Indicator, Reusable/One-Time Use Indicator, and/or Customer Specific data (CDM, etc.). In some exemplary embodiments, product database may include data for locally hosted products stored in data storage devices of one or more local computers. In some exemplary embodiments, one or more additional or alternative databases may include punch-out products, i.e., remotely hosted products, such as databases stored in data storage devices of (hosted via) one or more remote vendor computers. “Processor” or “computer” as used herein includes, but is not limited to, any programmed or programmable electronic device or coordinated devices that can store, retrieve, and process data and may be a processing unit or in a distributed processing configuration. Examples of processors include microprocessors, microcontrollers, graphics processing units (GPUs), floating point units (FPUs), reduced instruction set computing (RISC) processors, digital signal processors (DSPs), field programmable gate arrays (FPGAs), etc. In exemplary embodiments, product procurement system 135 provides a virtual market to purchasers, such as purchasers using user devices 105 (via browser 130). Product procurement system 135 may include logic that provides a user interface for purchasers to search for products in product database 125, receives a user query for one or more products, queries product database 125 for products corresponding to the user query, and displays select products to the user in response to the user query. For example, query processing engine 115 may receive queries provided by the user, determine one or more products from product database 125 that are responsive to the provided query, and provide a result set to the user via browser 130.

Price Agreement database 140 may include information related to product prices and price incentives, such as price volume thresholds, price tier thresholds, price adjustment rates, administrative fee rates, GPO share-back rates, effective dates for one or more price adjustments, available on one or more products that a user may select and/or purchase. For example, price agreement database 140 may include available unit of measure and include price information related to each unit of measure. In some exemplary embodiments, price records in price agreement database 140 may include: a unique product identifier, a Price Code, Unit of Measure(s), Price Adjustment Rate(s), Price Adjustment Rate thresholds, Price Effective dates, Price Terms such as: Minimum Quantities, Maximum Quantities, Ordering Multiples, Customer Purchase Activity Commitment Tiers, and/or Customer Specific data (Charge codes, Purchase From, Inventory Location identifiers, etc.). (GPO's recover administrative fees from suppliers and share those administrative fees with users of those contracts based on a pre-negotiated rate with the health system. Suppliers pay administrative fees to the GPO who then distributes it to the Providers based on contractual arrangements. Typically, administrative fees are paid on any contract item spend; although they are called administrative fees, they are not restricted to Administrative Services.) In some exemplary embodiments, price agreement database may include data for locally hosted prices stored in data storage devices of one or more local computers. In some exemplary embodiments, one or more additional or alternative databases may include punch-out price enquiries, i.e., remotely hosted product prices, such as databases stored in data storage devices of (hosted via) one or more remote vendor computers.

Exemplary systems have logic for performing the various functions and processes described herein. “Logic,” synonymous with “circuit” as used herein includes, but is not limited to, hardware, firmware, software and/or combinations of each to perform one or more functions or actions. For example, based on a desired application or needs, logic may include a software controlled processor, discrete logic such as an application specific integrated circuit (ASIC), programmed logic device, or other processor. Logic may also be fully embodied as software. “Software,” as used herein, includes but is not limited to one or more computer readable and/or executable instructions that cause a processor or other electronic device to perform functions, actions, processes, and/or behave in a desired manner. The instructions may be embodied in various forms such as routines, algorithms, modules or programs including separate applications or code from dynamically linked libraries (DLLs). Software may also be implemented in various forms such as a stand-alone program, a web-based program, a function call, a subroutine, a servlet, an application, an app, an applet (e.g., a Java applet), a plug-in, instructions stored in a memory, part of an operating system, or other type of executable instructions or interpreted instructions from which executable instructions are created. It will be appreciated by one of ordinary skill in the art that the form of software is dependent on, for example, requirements of a desired application, the environment it runs on, and/or the desires of a designer/programmer or the like. In exemplary embodiments, some or all of the software is stored on memory, which includes one or more non-transitory computer readable media of one or more local or remote data storage devices (for remote memories, system will include a communications circuit). As used herein, “data storage device” means a device for non-transitory storage of code or data, e.g., a device with a non-transitory computer readable medium. As used herein, “non-transitory computer readable medium” mean any suitable non-transitory computer readable medium for storing code or data, such as a magnetic medium, e.g., fixed disks in external hard drives, fixed disks in internal hard drives, and flexible disks; an optical medium, e.g., CD disk, DVD disk, and other media, e.g., ROM, PROM, EPROM, EEPROM, flash PROM, external flash memory drives, etc.

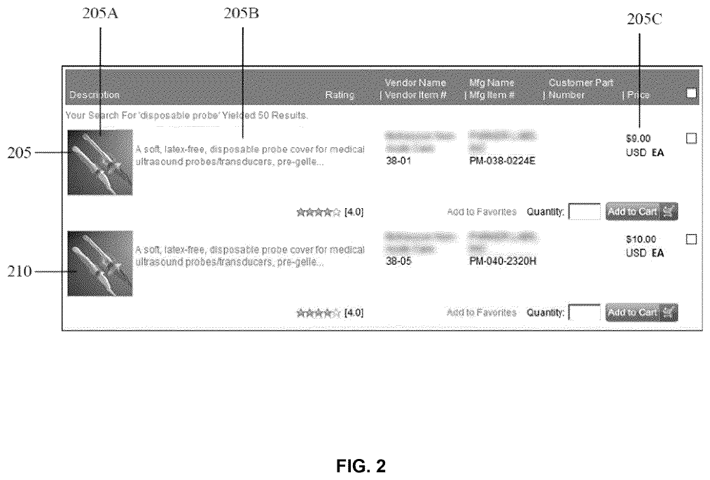

For example, referring to FIG. 2, an example of a result set of products that may be provided to a user is illustrated. The illustrated display may be provided to a user via browser 130 in response to a query that has been submitted by the user. For example, the user may submit the query “disposable probe” to product procurement system 135 via a web-based interface, and query processing engine 115 may determine a set of result products from product database 125 that are responsive to the search query. Query processing engine 115 may retrieve information related to the responsive products from product database 125 and price agreement database 140 and further provide the relevant information to browser 130. For example, for product 205, query processing engine 115 and/or one or more other components may identify the product image 205A, the product description 205B, and/or the price 205C.

Query processing engine 115 receives search parameters from user device 105 and returns a result set to user device 105 that is responsive to the provided search. For example, a user uses a program, such as web browser 130, to enter search parameters to locate one or more cataloged products in the product database 125. Query processing engine 115 uses one or more search algorithms to search the product database 125 to determine which products are responsive to the search. Query processing engine 115 uses various attributes associated with products to determine which products are responsive to a search request. For example, query processing engine 115 may compare search terms with product names, part numbers, product descriptions, and/or other attributes of products to determine which products are responsive to a search.

In some exemplary embodiments, query processing engine 115 uses a fuzzy logic algorithm to determine potential matches to products. The fuzzy logic algorithm applies a grammar dictionary to parse one or more key data attribute values within a result set to determine a match relevance score. The algorithm may then apply fuzzy matching logic using one or more distance algorithms to increase match hit rates on look-up key values based on acceptable distance matching thresholds between the identified data attribute values and one or more potential matches. Potential matches that satisfy a threshold matching value may be selected in a result set of products to be provided to the user in the order of the relevance score.

In some exemplary embodiments, query processing engine 115 may rank one or more products in a search result before providing the user with the results via browser 130. For example, query processing engine 115 may rank products based on one or more matching scores and/or matching coefficients that were determined by the search algorithm utilized to determine the matches. Also, for example, query processing engine 115 may rank products so that products from preferred vendors and/or products that are subject to price incentives may be promoted in provided ranked search results.

In some exemplary embodiments, query processing engine 115 uses rebate data, price incentive data and/or purchase history data to determine rankings of products. For example, when determining a search result set to provide a user via user device 105, query processing engine 115 may identify products in the search result set that are associated with price incentives, and promote those products in a search result set. In some exemplary embodiments, query processing engine 115 may prune a result set before providing the results to the user via user device 105 to remove products that are not associated with a preferred vendor and/or that are not associated with a price incentive in an effective the price agreement. For example, a search result may include two results, one with a purchasing agreement that is close to being fulfilled and a second product that is not associated with a bulk purchasing agreement. Query processing engine 115 may rank the second product lower in a provided result set and/or may remove the product from the result set that is provided to the user based on the price term data and/or purchase history data indicating that, if the user were to select the first result for purchase, an agreement that would reduce the purchasing price would be closer to fulfillment and/or that a price incentive would be incurred by the purchaser.

In exemplary embodiments, Price Optimization engine 110 receives price incentive information from a user and store the price incentive information in rebate database 120 or the price agreement database 140. Additionally, price optimization engine 110 may associate a product in product database 125 with existing price incentives and/or identify a product in product database 125 to associate with a new price incentive. A user may provide a price incentive structure to price optimization engine 110 via user device 105. For example, a user may be provided with an interface to enter price incentive information via browser 130, and price optimization engine 110 may store the price incentive information in rebate database 120 or the price agreement database 140. In some exemplary embodiments, price optimization engine 110 may then identify products in a result set that has been determined by query processing engine 115, and further determine whether any price incentives associated with the identified products are close to fulfillment. If a product in the result set is close to a price incentives fulfillment threshold, price optimization engine 110 may provide query processing engine 115 with a signal indicative of the product's fulfillment status. Query processing engine 115 may then utilize the provided signal to increment the relevance score to impact the rank of the products in the result set.

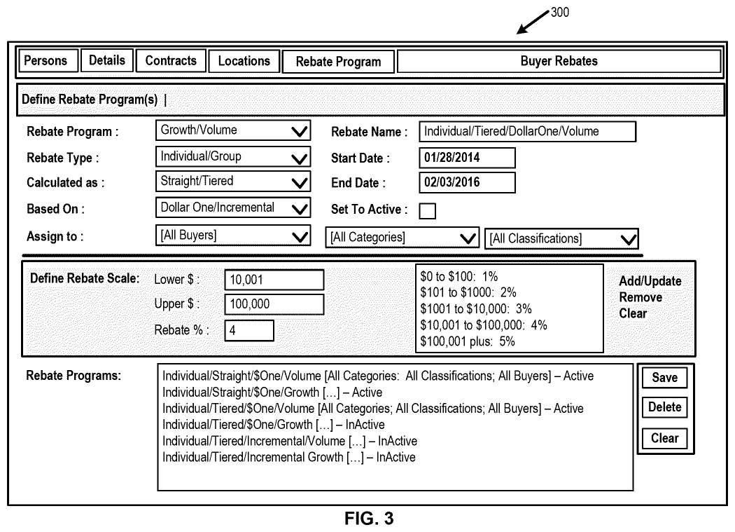

Referring to FIG. 3, a graphical interface for providing rebate structure is illustrated. The interface 300 includes interactive items that allow a user to enter information regarding a rebate, such as the type of rebate, the structure of the rebate, the start and end dates of the rebate, and the products to associate with the rebate. The user may then submit the rebate information to price optimization engine 110, which may process the information and store the rebate structure in rebate database 120. In some exemplary embodiments, price optimization engine 110 may further store information in product database 125 to indicate which products are associated with price incentives. For example, a user may provide price optimization engine 110 with a rebate structure for “Product A,” and price optimization engine 110 may store the rebate structure in rebate database 120 and further update the record in product database 125 associated with “Product A” with an indication that a rebate exists for “Product A.” If query processing engine 115 determines a result set for a query that includes “Product A,” price optimization engine 110 may identify that “Product A” is associated with a rebate, access the rebate, and provide an indication to query processing engine 115 to indicate the current status of the rebate.

Price incentives in the form of rebates may be structured in several different forms. In exemplary embodiments, rebate structures include one or a combination of two or more of the following:
Individual: rebate based on the purchases of a single purchaser or user.
Group: rebate based on all purchasers from a defined group of users.
Dollar One rebates: rebate applies to all sales, starting at the first unit sold in a time period. For example, a “dollar one” rebate may include “1% of all sales in 2015.”
Tiered rebates: rebate percentage changes depending on one or more thresholds.

Thresholds may include, for example, total number of products purchased, total dollar amount, and total growth over a time period. For example, a tiered rebate may be “1% of total sales from 0 to $10,000; 2% of sales above $10,000.” Also, for example, a tiered rebate may be “1% of total sales if less than $10,000; 2% if sales are above $10,000.” Also, for example, a tiered rebate may include no rebate until a threshold is satisfied (e.g., “2% only if sales are above $10,000”). Similarly, tiered rebates may be associated with number of products sold as opposed to dollar amount.

Examples of other price incentive forms, which may be subject to one or more terms stored in the price agreement data, may include a combination of one or more of the following:
Price Tiers: one or more adjusted product price scales based on customer's volume or purchase thresholds.
Administrative Fees: a recoverable price adjustment subject to a negotiated rate that is to be distributed back to the purchaser based on their purchase activity.
Volume Prices: product price adjustments based on the volume of units purchased.

In some exemplary embodiments, price optimization engine 110 may track purchases made by users for each product that is associated with a price incentive and further track price incentive structures that have been satisfied. For example, for “Product A” with a rebate structure of “1% of total sales if less than $10,000; 2% if sales are above $10,000,” price optimization engine 110 may store the current number of “Product A” that has been sold within a time period specified by the rebate (e.g., per fiscal year) and/or price optimization engine 110 may store an indication of the volume of sales of “Product A” that is required for a rebate or a rebate tier to be fulfilled. For example, if $9,500 of “Product A” has been purchased by the user in the current fiscal year, price optimization engine 110 may store, in rebate database 120 with the record associated with the rebate and/or in product database 125 (with the record associated with “Product A,” an indication that a 1% rebate is in effect, an indication that $500 of sales of “Product A” is required for an additional rebate of 2%, and/or one or more other indications of the current volume of purchases of “Product A.”

Query processing engine 115 may receive one or more signals from price optimization engine 110 to indicate, for products in a result set that has been determined, whether products are associated with price incentives. For example, query processing engine 115 may determine a set of results that includes “Product A” and “Product B.” Price Optimization engine 110 may identify a rebate or price incentive associated with “Product B” and provide query processing engine 115 with an indication of the rebate or price incentive, the current status of the rebate or price incentive, the volume of Product B that is required to fulfill a tier of a rebate or purchase threshold, and/or one or more other indications of the price incentive. In some exemplary embodiments, price optimization engine 110 may determine a score based on the price incentive associated with Product B and provide query processing engine 115 with the score. For example, for a price incentive term of a product that has been fulfilled, price optimization engine 110 may determine a score for the product that is more indicative of importance than a second product with a price incentive term that still requires $10,000 in purchases before becoming active. Also, for example, price optimization engine 110 may determine a score for a product that requires $500 in sales before the price incentive term is active that is more indicative of importance than a second product with a price incentive term that has already been fulfilled (i.e., the purchaser may have more interest in a product that is almost eligible for a price incentive to satisfy the threshold amount than a product that has already satisfied a price incentive threshold).

Additional and/or alternative signals may be utilized by price optimization engine 110 in determining a score to associate with a product that is eligible for a price incentive. For example, the percentage of a price incentive, the amount of money saved by a price incentive, sales trends for a product, historical purchases of the user, and/or one or more other signals may be utilized by price optimization engine 110 for a given price incentive in order to determine a score for the current status of the price incentive.

In some exemplary embodiments, price optimization engine 110 may provide one or more interfaces to indicate to a purchaser and/or to an administrator of a purchaser the current status of one or more price incentives. For example, for a purchaser, price optimization engine 110 may determine the amount of money saved by the purchaser over a time period based on the sales of products with price incentives over that time period. Also, for example, price optimization engine 110 may determine trends in purchases to determine whether a price incentive is likely to become active within a time period. For example, price optimization engine 110 may determine that, for Product A, users purchase an average of $2,000 per month. In that example, if a price incentive for Product A is active for two more months and users have purchased $9,000 so far in the time period, price optimization engine 110 may determine that it is likely that the price incentive will become active and may provide a purchaser and/or user with an indication of savings that will likely be incurred by the end of the time period.

In some exemplary embodiments, query processing engine 115 may utilize scores provided by price optimization engine 110 to determine and/or adjust a ranking of products in a result set. Query processing engine 115 may first determine a ranking of products in a result set based on the search algorithm utilized to identify the products. For example, a set of products may be identified utilizing a Boyer-Moore search algorithm and scores may be assigned to each of the results based on likelihood that each of the result is responsive to the query of the user. In some exemplary embodiments, query processing engine 115 may adjust the scores and/or otherwise rerank the results based on the scores determined by price optimization engine 110.

As an example, referring again to FIG. 3, product 205 is provided more prominently (i.e., higher in a list of search results) than product 210. Query processing engine 115 may have determined the ranking by determining scores for both product 205 and 210 and provided product 205 first by determining that the score associated with product 205 is more indicative of importance than the score for product 210. Alternatively, query processing engine 115 may have initially determine that the score associated with product 210 is more indicative of importance, but price optimization engine 110 may have determined that product 205 is associated with a price incentive and further provided a score for product 205 that is indicative of current status of the price incentive (e.g., price incentive is active, price incentive is close to active). Query processing engine 115 may re-rank the products based on the score provided by price optimization engine 110 and furthermore display product 205 first based on the adjusted rankings.

In some exemplary embodiments, a user may indicate the effect that price incentives may have on rankings of products. For example, an administrator may configure query processing engine 115 so that any products associated with price incentives are always displayed first, promoted one or more places in the list of search results, and/or displayed differently than other products (e.g., highlighted, provided with a “Price Incentive Available” indication). In some exemplary embodiments, a combination of user/administrator input and scoring may be utilized to determine the order in which results are displayed to the user that submitted the search query.

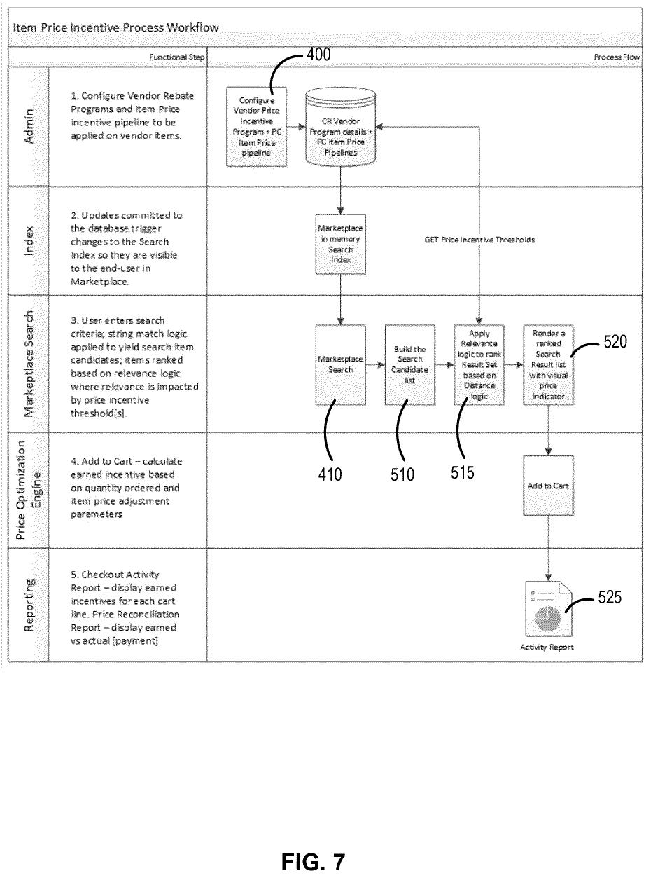

Referring to FIG. 7, a process flowchart is provided that may be utilized for an online product procurement system. At the administrative level 700, vendors' price incentives may be configured and stored. For example, an administrative user may be provided with an interface that shares one or more characteristics with FIG. 3 and may provide price incentive information that is stored in one or more databases. At the index level 705, updates to the database(s), such as purchases of items, updates to price incentive structures, and/or other changes are identified to further update information related to fulfillment of price adjustment terms. For example, a search result may need to be updated to illustrate that a price incentive is active, and an index for that search result may similarly require updating so that, when rendered to a user, the now-active price incentive is represented in a search result.

At the marketplace search level 710, the user conducts a search. The search query is received by the system, such as by a component that shares one or more characteristics with query processing engine 115. Query processing engine 710 builds a search candidate list utilizing one or more search algorithms and then applies relevance scores that are determined by price optimization engine 110 at 712, as described herein. A ranked search result list is then determined by query processing engine 115, which results in a rendered list of items that are both responsive to the user's request and ranked based on price incentives associated with items in the result set.

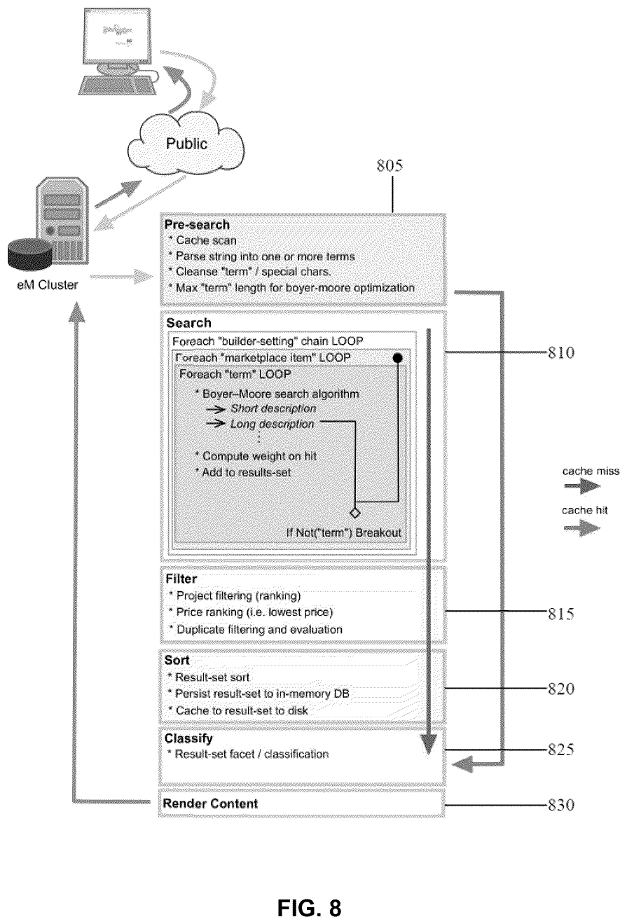

As an example of how search queries may be processed and results rendered by query processing engine 115, referring to FIG. 8, a process flow chart that may be utilized for an online product procurement system search engine is provided. At the pre-search step 805, the initial search query is processed. For example, caches of previous searches may be scanned to determine whether a similar or identical search has been previously submitted and search results cached. If so, the cached results may be provided for the new search query. Additionally, the search query may be parsed, cleansed of extraneous tokens, and/or truncated.

At the search step 810, if the cache scan does not identify an already cached search result set, a search is conducted. A search algorithm, such as the Boyer-Moore algorithm, is executed for each term that was determined from the pre-search step 805. One or more alternative search algorithms may be utilized at this step. As results are identified at step 810, weights may be determined for the results. For example, query processing engine 115 may determine weights to assign to results based on likelihood of each result being responsive to the submitted query.

Additionally, price optimization engine 110 may adjust weights and/or scores associated with results based on price incentives associated with items in the result set, as described herein. At step 815, the results are ranked. Ranking may be determined based on the weights associated with the results, additionally scores that are determined based on price incentive terms (e.g., relevance logic 712), pricing of the items in the result set, and/or other indications of importance of one or more of the results. Additionally, duplicates may be removed from the result set, lower ranking results may be removed from the result set, and/or other filtering may be performed on the result set before sorting.

Moreover, price optimization engine 110 may not be limited to optimizing based on price, but may also (or alternatively) adjust weights and/or scores associated with results based on environmental, social, governance (ESG) factors, diversity factors and/or other indications of social importance associated with items in the result set. In fact, the system may incorporate multi-factor weighting of one or more of the different attributes discussed herein. The multi-factor weighting may include any combination or subset of price incentive terms, pricing of the items in the result set, ESG factors, diversity factors and/or any other indications of financial or social importance of one or more of the results. The system may store data about ESG factors, diversity factors or any of the other factors associated with any or all of the items. In various embodiments, the system may store such data in product database 125, price optimization engine 110 or another database associated with ESG factors, diversity factors and/or other indications of social importance. In various embodiments, the system may receive data about ESG factors, diversity factors or any of the other factors by acquiring data from (e.g., via a data feed from) any of the organizations or entities that provide ESG data and/or diversity data about products or companies. In various embodiments, the system may receive and utilize user input about ESG factors, diversity factors or any of the other factors.

In various embodiments, the user may also provide input on how much weighting should be applied to one or more of the ESG factors, diversity factors or any of the other factors. For example, the system may list on a display the various ESG factors, diversity factors or any of the other factors. The system may provide a field next to each of the factors such that the user may enter a grade, code, ranking or percentage weighting next to certain factors. If the user enters a grade, code or ranking of different factors, then the system may assign a weight to the user-scored factors, wherein the higher scored factors would receive a higher weighting. The system may rank the results. The system may determine the ranking based on the ESG and/or diversity weights associated with the results. The system may determine the scores (e.g., using relevance logic 712) based on ESG, diversity and/or other indications of social importance of one or more of the results.

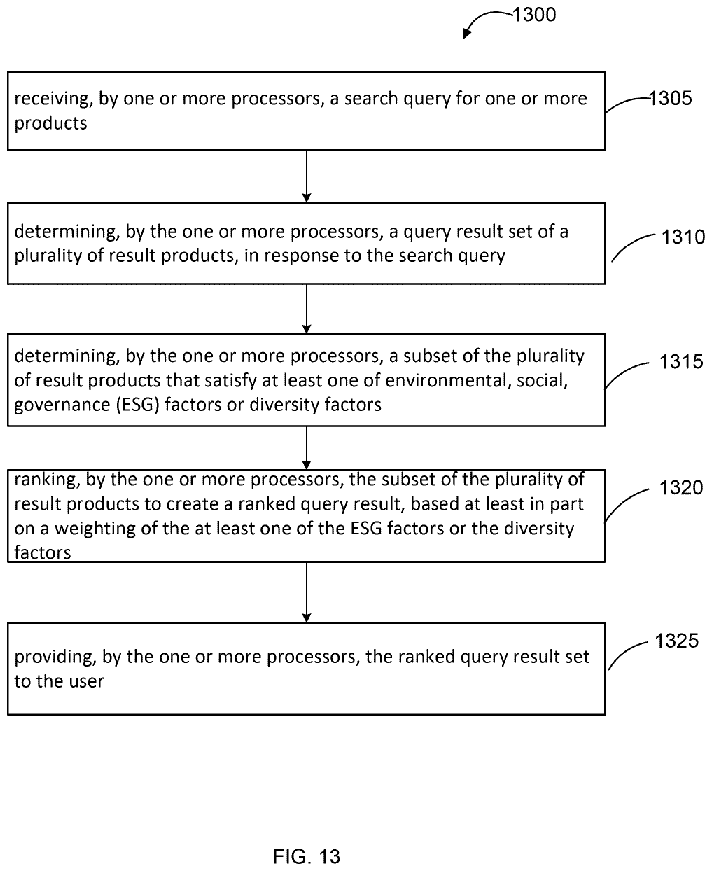

As set forth in FIG. 13, the system may perform a method comprising receiving, by one or more processors, a search query for one or more products (step 1305); determining, by the one or more processors, a query result set of a plurality of result products, in response to the search query (step 1310); determining, by the one or more processors, a subset of the plurality of result products that satisfy at least one of environmental, social, governance (ESG) factors or diversity factors (step 1315); ranking, by the one or more processors, the subset of the plurality of result products to create a ranked query result, based at least in part on a weighting of the at least one of the ESG factors or the diversity factors (step 1320); and providing, by the one or more processors, the ranked query result set to the user (step 1325).

The ESG factors may include any environmental, social, governance and/or non-financial factors impacting a company's long-term success. While the ESG factors may not be financial factors, the ESG factors may impact a company's financial performance and impact society. ESG may relate to how a company's operations impact the environment, how the company manages relationships with others (e.g., employees, suppliers, customers, and communities), and the quality of the company leadership, audits, internal controls, and shareholder rights. Some of the ESG attributes may include environmental sustainability, social impact, the quality of the company's governance practices. The environmental factors may include a company's performance as a steward of the natural environment, including energy use, waste, pollution, natural resource conservation, and/or treatment of animals. The factors may also involve a company's environmental risks and how the company manages those risks. The social factors may include a company's management of its relationships with employees, suppliers, customers, and the communities where it operates. The social factors may include labor practices, product safety, data protection, and privacy. The governance factors may include a company's leadership, executive pay, audits, internal controls, and shareholder rights. The ESG and/or diversity factors may be associated with the item, the supply chain for the item, the components, composition and/or ingredients of the item, the sourcing of the item, the impacts of the item, the company selling the items, the parent company of the company selling the item, the affiliates or subsidiaries of the company selling the item, the inventory for the item, the availability of the item, the location of the items and transportation issues associated with delivering the item, the manufacturing practices associated with the item, the diversity profile of the officers, employees or contractors of the companies associated with the item, and/or the like.

For example, at step 820, the system may sort the results. The system may store a cached result set in one or more databases for later utilization at step 805 for a future search query. The system may sort a result set such that the result with a weight or score most indicative of importance is first in the sorted list, with the next most indicative next, etc. In some exemplary embodiments, the system may sort results associated with price incentives, ESG and/or diversity higher in the sorted list, than products that are not associated with price incentives, ESG and/or diversity. For example, if two products in a result set are associated with price incentives, ESG and/or diversity, those products may always be sorted to the first and second positions in the result set.

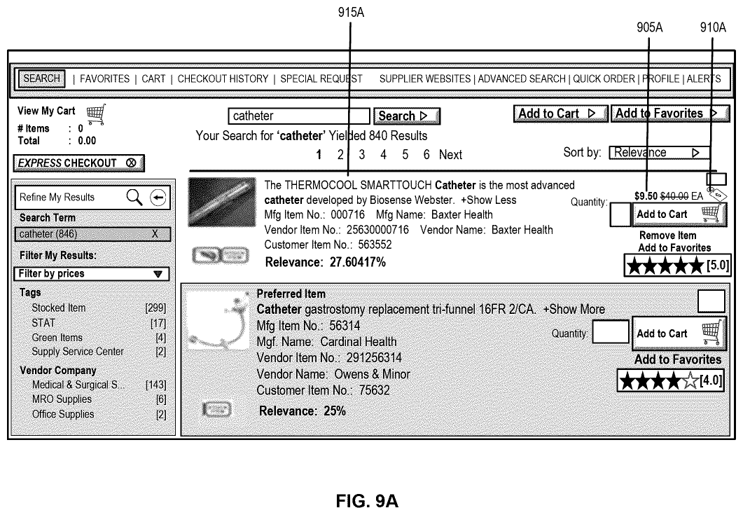

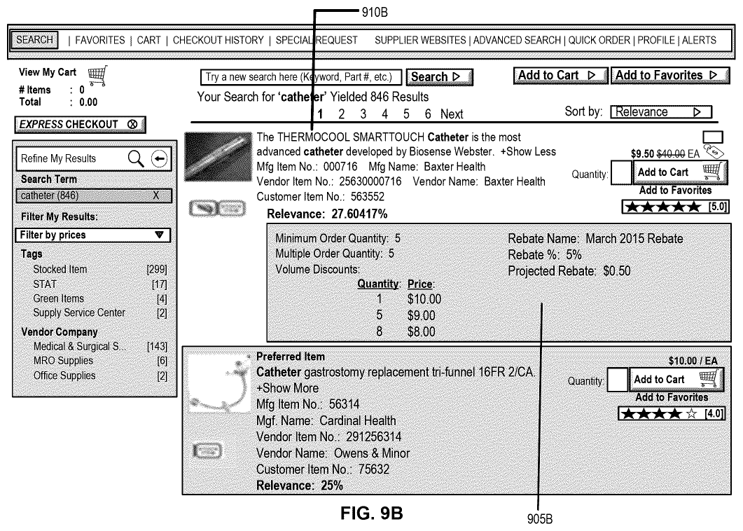

At step 825, the result set is classified where price incentive eligible items may be segmented and identified [highlighted] to the user in the browser 130. Referring to FIG. 9A, the segmented items will display in the classification navigation 920 as “Preferred Items”.

At step 830, the results are rendered to the user. The results may be rendered utilizing an interface that shares one or more characteristics with the interfaces provided in FIGS. 2, 9A, and 9B, and described herein. The results may be rendered utilizing a web browser, such as browser 130.

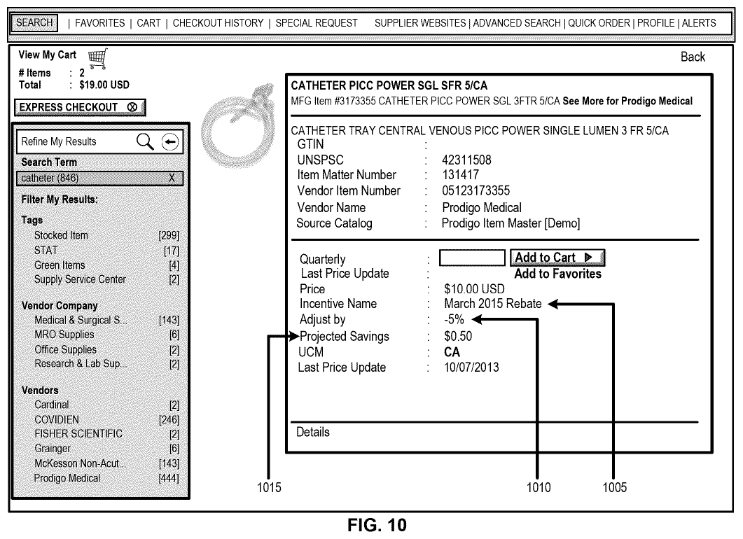

Referring again to FIG. 7, at the price optimization engine level 715, price incentives that are active for an item that has been selected for purchase are determined and provided to the user. For example, referring to FIG. 10, an interface is provided that may be utilized to provide a user with price adjustment information at the point of purchase. The interface displays the price 1005 of the product, the price adjustment percentage 1010, and the projected savings 1015. In some exemplary embodiments, price optimization engine 115 may additionally determine a discount amount to provide along with the illustrated information. For example, for the interface illustrated by FIG. 10, price optimization engine 115 may additionally display “Discount price: $9.50;” that is, the price 1005 minus the projected savings 1015. In some exemplary embodiments, price optimization engine 115 may provide a discount price after the user has selected a quantity. For example, if a user purchase is large enough to satisfy a threshold, thereby increasing the price incentive amount, price optimization engine 115 may provide the projected savings after the amount has been submitted by the user.

At the reporting level 720, one or more reports may be generated for utilization by a user, such as an administrative user, to monitor checkout activity of users. The reports may include, for example, earned rebates for each purchase, total earned rebates, earned admin fees and/or other indications of whether price adjustments have been incurred. The reports generated at the report level 720 may additionally include totals actually paid by vendors to ensure that price incentives have been honored by vendors and to remedy any discrepancies in billings.

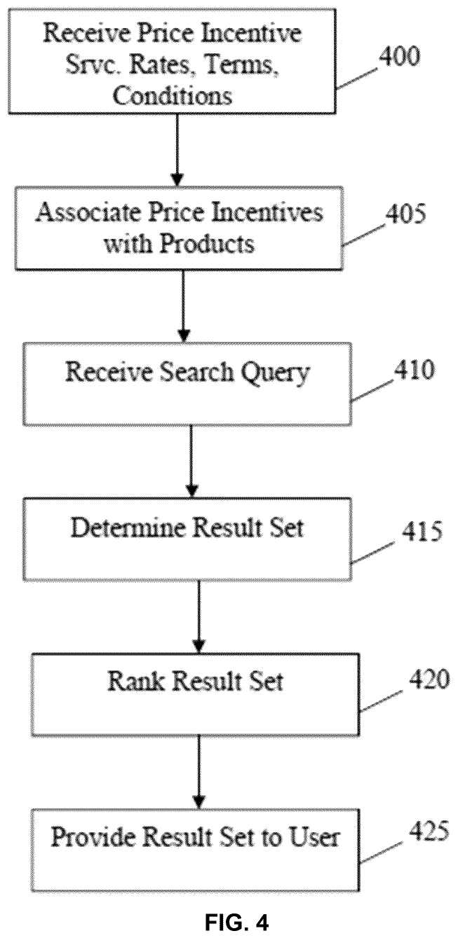

Referring to FIG. 4, a flow chart is provided that illustrates an example method for ranking search results based on price incentives. Other implementations may perform the steps in a different order, omit certain steps, and/or perform different and/or additional steps than those illustrated in FIG. 4. The steps of the method illustrated in FIG. 4 may be performed by one or more components illustrated in FIG. 1. The illustrated method receives a search query from a user, determines a query result set of products that is responsive to the search query, and ranks the search result set based on price incentive structures associated with one or more of the products of the result set. The ranked result set is then provided to the user.

At step 400, a plurality of price incentive structures is received. The price incentive structures may be received from a user that utilizes an interface that shares one or more characteristics with the interface illustrated in FIG. 3 via a browser, such as browser 130. In some exemplary embodiments, one or more price incentive structures may be received via a file that is generated by one or more other systems. For example, an invoicing system of a vendor may create a file that includes price incentive structure information, such as price adjustment rate, price incentive amount, volume of sales for tiers of a price incentive, price incentive start and/or end date, and/or product information. The file may be provided to one or more components of a product procurement system, such as price optimization engine 110. The price incentive structure may be stored in a database, such as rebate database 120 or price agreement database 140.

At step 405, the price incentive structures are associated with products. The products associated with price incentive structures may be associated with products by a component that shares one or more characteristics with price optimization engine 110. In some exemplary embodiments, price incentive structure may include information related to past purchases of products that are associated with the price incentive. For example, price optimization engine 110 may receive a price incentive structure (either from a user or from another system) that includes product information and additionally includes the volume of purchases of the product by the purchaser, such as by all users associated with an organization. Price Optimization engine 110 may then identify the product or products associated with the price incentive in a database of products, such as product database 125. In some exemplary embodiments, price optimization engine 110 may identify past purchases of the price incentive products in product database 125 and store past purchase information with the price incentive structure in rebate database 120 or the price agreement database 140. For example, price optimization engine 110 may receive a price incentive structure at step 400, associate a product or products from product database 125 with the price incentive structure, and further determine the volume of sales of the product(s) over a time period. The sales volume may be stored in rebate database 120 with the rebate information or the price agreement database 140 with the price incentive.

At step 410, a search query is received from a user. The query may be provided by a device that shares one or more characteristics with user device 105. For example, product procurement system 135 may provide an interface to a user via browser 130 and the user may utilize the interface to provide a text-based search query. Once the user submits the search query, the query may be provided to product procurement system 135. For example, the query may be provided to query processing engine 115, which may further process the search query (e.g., truncate, remove non-essential characters) and execute one or more search algorithms based on the resulting string or strings.

At step 415, a query result set is determined in response to the search query received at step 410. The query result set may be determined by a component that shares one or more characteristics with query processing engine 115. For example, query processing engine 115 may utilize one or more search algorithms to determine, based on the received search query, a result set that includes one or more products from products database 125 with prices from the price agreement database 140. In some exemplary embodiments, query processing engine 115 may provide the search results and/or indications of products in the result set (e.g., record numbers) to price optimization engine 110. Price optimization engine 110 may identify one or more products from the result set that are associated with price incentive structures and further indications of the price incentive structure and/or the status of associated price incentive structures to query processing engine 115.

For example, query processing engine 115 may identify Product A, Product B, and Product C as responsive to the search query of the user. Query processing engine 115 may provide indications of the three products to price optimization engine 110. Price optimization engine 110 may identify a price incentive structure that is associated with Product B, and further provide query processing engine 115 with an indication that Product B is associated with a rebate. In some exemplary embodiments, the indication may further include, for example, information regarding whether the price incentive is active, how close the volume of sales is to fulfilling the price incentive and/or a tier of a tiered price incentive, past sales and/or sales trends of purchases of the product by the user and/or other purchasers associated with the user, and/or other information that may be utilized by query processing engine 115 in determining the importance of a product that is associated with a price incentive.

At step 405, the price incentive structures are associated with products. The products associated with price incentive structures may be associated with products by a component that shares one or more characteristics with price optimization engine 110. In some exemplary embodiments, price incentive structure may include information related to past purchases of products that are associated with the price incentive. For example, price optimization engine 110 may receive a price incentive structure (either from a user or from another system) that includes product information and additionally includes the volume of purchases of the product by the purchaser, such as by all users associated with an organization. Price Optimization engine 110 may then identify the product or products associated with the price incentive in a database of products, such as product database 125. In some exemplary embodiments, price optimization engine 110 may identify past purchases of the price incentive products in product database 125 and store past purchase information with the price incentive structure in rebate database 120 or the price agreement database 140. For example, price optimization engine 110 may receive a price incentive structure at step 400, associate a product or products from product database 125 with the price incentive structure, and further determine the volume of sales of the product(s) over a time period. The sales volume may be stored in rebate database 120 with the rebate information or the price agreement database 140 with the price incentive.

At step 425, the ranked query result set is provided to the user. The ranked query result set may be provided to the user by one or more components of a system that shares one or more characteristics with product procurement system 135. The result set may be provided via a web interface that shares one or more characteristics with the interface illustrated in FIG. 2 via a browser that shares one or more characteristics with browser 130.

For example, referring to FIGS. 9A and 9B, illustrations are provided of interfaces that may be utilized to provide a user with search results ordered by existing price incentives. For result 915A, a description of the product, image, and other information is provided. Additionally, a price 905A is provided with the search result. The price 905A, as illustrated, includes the discount that would be applied to purchases based on a price incentive. For example, the price “$10.00” is provided, but with a strikeout to indicate that “$10.00” is not the price, but instead that “$9.50” is the current price per item. This reflects, for example, a 5% price adjustment that is in effect for purchases of that product. Additionally, an indication of the price incentive 910A may be provided with results that are associated with active price incentives to indicate to the user that a cost savings is in effect for purchases of that marked product. Referring to FIG. 9B, additional information 905B related to a price incentive may be provided with one or more results. For example, for additional information 905B, a tiered price incentive is provided which indicates the different price adjustments available for purchases of product 910B. Further, as illustrated, a minimum purchase amount has been set for purchases of product 901B. This may be set by the vendor and/or an administrative user.

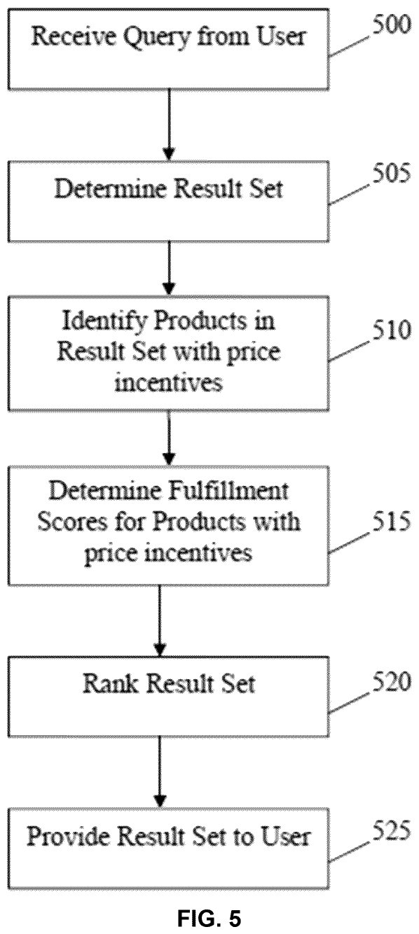

Referring to FIG. 5, a flow chart is provided that illustrates another example method for ranking search results based on price incentives. Other implementations may perform the steps in a different order, omit certain steps, and/or perform different and/or additional steps than those illustrated in FIG. 5. The steps of the method illustrated in FIG. 5 may be performed by one or more components illustrated in FIG. 1. The illustrated method receives a query from a user, determines a result set of products responsive to the query, identifies price incentive structures associated with one or more of the products of the result set, and ranks the result set based on the identified rebate structures. The ranked result set is then provided to the user.

At step 500, a query is received from a user. Step 500 may share one or more characteristics with step 410 of the method illustrated in FIG. 4. For example, a search query may be provided by a user via a browser 130 executing on a device, such as user device 105. The query may be received by a component that shares one or more characteristics with query processing engine 115.

At step 505, a result set is determined in response to receiving the query. Step 505 may share one or more characteristics with step 415 of FIG. 4. For example, query processing engine 115 may utilize one or more search algorithms to determine a result set that includes one or more products from product database 125.

At step 510, one or more of the products of the result set are identified as price incentive products. In some exemplary embodiments, query processing engine 115 may provide products of the result set to price optimization engine 110, which may then identify any price incentives associated with the products from rebate database 120 or the price agreement database 140. The price incentive structures in rebate database 120 or price agreement database 140 may have been previously submitted by users and/or provided by one or more other systems, such as by a rebate and/or invoicing system of a vendor. In some exemplary embodiments, price optimization engine 110 may further identify information related to past sales of products associated with price incentives.

At step 515, a fulfillment score is determined for each of the price incentive eligible products. The fulfillment score may be determined by a component that shares one or more characteristics with price optimization engine 110. In some exemplary embodiments, price optimization engine 110 may determine a score for each product that is associated with a price incentive. For a given product that is associated with a price incentive, price optimization engine 110 may determine a score based on any one or more of the following criteria:
Whether the price incentive associated with the product is currently active.
Whether additional purchases of the product would likely satisfy a price incentive term threshold.
Whether historical trends in purchases of the product are indicative of likelihood that the price incentive term will be satisfied within the time period set for the price incentive (e.g., within the current fiscal year or calendar year).

Price optimization engine 110 may use any combination of factors to determine scores for each of the products associated with price incentives. In some exemplary embodiments, additional and/or alternative input from one or more users may be utilized to determine fulfillments scores. For example, an administrative user may indicate how one or more factors utilized to determine a score affect the score. The administrative user may determine, for example, that fulfillment scores should be based solely on whether a price incentive exists for a product (e.g., a score of “1” for products with price incentives and a score of “0” for products without price incentives). Also, for example, the administrative user may indicate that price incentives that are close to fulfillment should be given higher scores than products with price incentives that are already fulfilled and/or that are not as close to being fulfilled.

At step 520, the products of the result set are ranked based on the fulfillment scores of the products. In some exemplary embodiments, query processing engine 115 may determine an initial ranking of the products in the result set. For example, query processing engine 115 may utilize a search algorithm that scores one or more products in product database 125 based on likelihood that the product(s) are responsive to the search query. Query processing engine 115 may then select a set of products as a result set. For the products in the result set with associated price incentive structures, price optimization engine 110 may provide the fulfillment scores, as described in step 515. Query processing engine 115 may then determine new ranking and/or new scores for the products based on the fulfillment scores.

As an example, suppose query processing engine 115 identifies Product A, Product B, and Product C as responsive to a search query. The algorithm utilized be query processing engine 115 may determine that a score associated with each product is as follows: Product A with a score of 1.0, Product B with a score of 0.9, and Product C with a score of 0.85. Further, query processing engine 115 determines that Product B is associated with a price incentive and further determines a fulfillment score of 1.5. Query processing engine 115 may calculate a new score for Product B by, for example, determining the product of the initial score and the fulfillment score (0.9 times 1.5, or 1.35). Based on the fulfillment score, query processing engine 115 may re-rank the result set such that the results are now ordered Product B (score of 1.35), Product A (score of 1.0), and Product C (score of 0.085).

At step 525, the ranked result set is provided to the user. In some exemplary embodiments, step 525 may share one or more characteristics with step 425 of FIG. 4. For example, a result set may be provided to a user via browser 130 utilizing an interface that shares one or more characteristics with the interface illustrated in FIG. 2.

FIG. 6 is a block diagram of an exemplary computer system 610. Computer system 610 typically includes at least one processor 614 which communicates with a number of peripheral devices via bus subsystem 612. These peripheral devices may include a storage subsystem 624, including, for example, a memory subsystem 626 and a file storage subsystem 628, user interface input devices 622, user interface output devices 620, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to identify and/or transmit actionable content from a computing device to one or more other computing devices based on the likelihood of a user having interest in accessing the actionable content from the other computing devices.

These software modules are generally executed by processor 614 alone or in combination with other processors. Memory 626 used in the storage subsystem can include a number of memories including a main random access memory (RAM) 630 for storage of instructions and data during program execution and a read only memory (ROM) 632 in which fixed instructions are stored. A file storage subsystem 628 can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem 628 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative embodiments of the bus subsystem may use multiple busses.

Computer system 610 can be of varying types including a workstation, server, computing cluster, blade server, server farm, or any other data processing system or computing device. Due to the ever-changing nature of computing devices and networks, the description of computer system 610 depicted in FIG. 6 is intended only as a specific example for purposes of illustrating some embodiments. Many other configurations of computer system 610 are possible having more or fewer components than the computer system depicted in FIG. 6.

Referring back to FIG. 7, in this exemplary embodiment, through a Prodigo Content Management System, rebate program details are configured on Vendor Company profiles which define the eligible rebate rate to be applied to Vendor Item purchase activity. Rebate Program attributes include one or more Purchase Volume Tier(s) which define one or more performance thresholds that are used to determine the eligible rebate rate that is to be applied on the purchase activity for that vendor. Additionally, price incentive terms are configured in the vendor Price Agreement which defines the price adjustment rate and conditions and/or thresholds where the price adjustment rate and/or price tier is to be applied. A Prodigo Marketplace Search Engine contains relevance logic 712 (including relevance algorithms) which uses Search Relevance Score Logic, e.g., term matching logic that determines matches (“hits”), and item level attribute scoring criteria in the Marketplace Database to calculate a Search Relevance Score, also called a Current Relevance Score. In a non-price incentive-influenced search engine, the Search Relevance Score is then used to order the search result in the Search Result view (displayed to a user on a computer display) from highest score items to lowest score items.

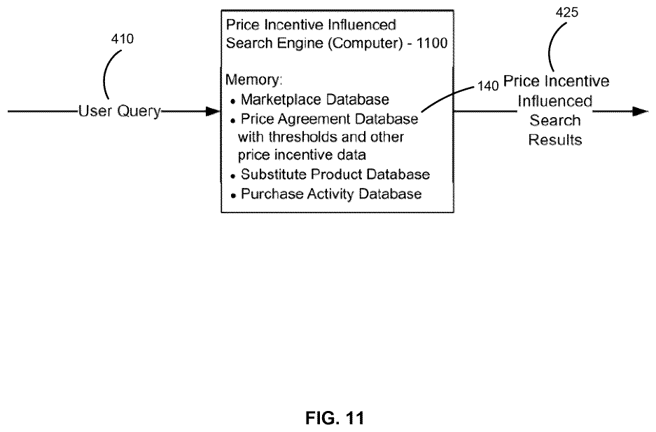

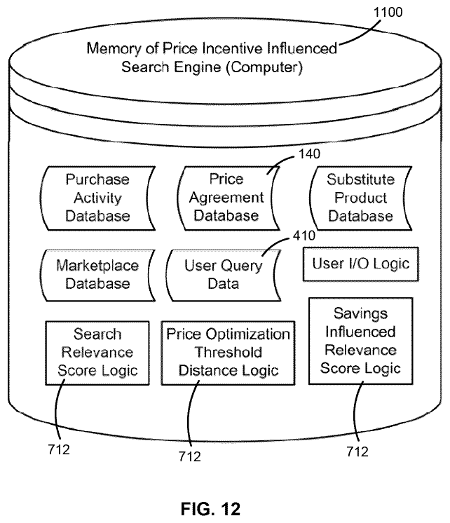

Referring now to FIGS. 11-12 in the context of FIG. 7, relevance logic 712 in a price incentive influenced search engine 1100 includes Price Incentive Influenced Relevance Score Logic that calculates a Price Incentive Threshold Distance (“PITD”), which PITD indicates how close a user (or company or other business unit associated with the user) is to triggering a next price incentive tier or threshold. Price Incentive Threshold Distance Logic (“PITD Logic”) uses the available vendor price incentive program tier threshold(s), defined for each vendor with item hits in the search result set determined by the Search Relevance Score Logic, to calculate the distance to the next available annual performance tier from the current annualized purchase volume. Optionally, the PITD Logic also includes while calculating the PITD a current amount of product identified for the current transaction (if available). The Price Incentive Influenced Relevance Score Logic will factor the Relevance Score on the search term candidate item by the PITD Coefficient to yield a higher search rank result. As the distance to the next tier thresholds shortens, the item is displayed to the user on a computer display in a higher position in the Search Result, e.g., the first page of a display on a computer display. In some exemplary embodiments, the Price Incentive Influenced Relevance Score Logic calculates the Price Incentive Influenced Relevance Score as follows:

PITD coefficient=(Annualized Purchase Activity/Next Price Incentive Tier)+1

Price Incentive Influenced Relevance Score=PITD coefficient×Current Relevance Score

FIG. 12 shows an exemplary Memory of an exemplary Price Incentive Influenced Search Engine, which includes a (a) Purchase Activity Database (stored on one or more data storage devices of one or more local and/or remote computer systems), including Purchase Activity data, (b) a Price Incentive Database (stored on one or more data storage devices of one or more local and/or remote computer systems), including price incentive tier data, including Next Price Incentive Tier threshold data, (c) a Substitute Product Database (stored on one or more data storage devices of one or more local and/or remote computer systems), including substitute product data used by the Search Relevance Score Logic for finding “hits,” (d) a Marketplace Database (stored on one or more data storage devices of one or more local and/or remote computer systems), including product data used by the Search Relevance Score Logic, (e) User Query Data received from the user for the present query, (f) User I/O Logic for receiving the User Query Data and sending signals to display to the user on a computer display the results of the price incentive-influenced query, (g) Search Relevance Score Logic (stored on one or more data storage devices of one or more local and/or remote computer systems), which calculates a non-incentive influenced Search Relevance Score as described herein, (h) Price Incentive Threshold Distance Logic (stored on one or more data storage devices of one or more local and/or remote computer systems), that calculates an PITD coefficient or other indicator of how close to a next price incentive the user is as describe herein, and (h) Price Incentive Influenced Relevance Score Logic (stored on one or more data storage devices of one or more local and/or remote computer systems), that calculates a Price Incentive Influenced Relevance Score and orders the candidate products responsive to the query as described herein. In some exemplary systems, items (a) through (h) are stored locally on local computers. In other exemplary systems, items (a) through (d) are stored on remote computers and items (e) through (h) are stored on local computers.

Some of the steps, acts, and other processes and portions of processes are described herein as being done “automatically.” In the alternative, or in addition thereto, those steps, acts, and other processes and portions of processes can be done with one or more intervening human acts or other manual acts that eventually trigger the mentioned step(s), act(s), and/or other process(es) and/or process portion(s).

Any portion of the data may be received in a non-standardized format. The format that the data is received may depend on the system that receives the data, the user's device that submits the data and/or the database that provides the data to the system. The system may convert the data in a non-standardized format into a standardized format before storing the standard data in a plurality of storage devices. The system may automatically generate a message (e.g., containing the updated data) whenever the updated data is stored and transmit the message to the users over a computer network in real time, so that the user has immediate access to the up-to-date data in a standard format. The system allows remote users to share data in real time in a standardized format, regardless of the format (e.g., non-standardized) that the information was input by the user. The system may include a filtering tool that is remote from the end user and may provide customizable filtering features to each end user. The filtering tool may provide customizable filtering by filtering access to the data. The filtering tool may identify data or accounts that communicate with the server and may associate a request for content with the individual account. The system may include a filter on a local computer and a filter on a server. The filtering tool may identify information or accounts that communicate with the server, and associate a request for content with the individual account. The system may also include an improved user interface with a functional display and/or structure to the interface functionality. The system may provide a particular manner of summarizing and presenting information in electronic devices. The system may include an application summary window that lists a limited set of data and the summary window may be displayed while the one or more other applications are not displayed (e.g., the other applications may be in an unlaunched state). As such, the system may display in an application summary window the items that meet certain standards or thresholds of price incentives, ESG factors and/or diversity factors, while other items that do not meet the standards or thresholds of price incentives, ESG factors and/or diversity factors are not displayed. As such, the system may include an improved user interface for suggesting and purchasing certain products that meet certain standards or thresholds of price incentives, ESG factors and/or diversity factors.

The system may train a neural network when using artificial intelligence or machine learning. The system may include an expanded data set of past data to train the neural network. The expanded training set may be developed by applying mathematical algorithms to the acquired set of data. The neural network is then trained with the expanded data set using a machine learning algorithm that uses a mathematical function to adjust certain weighting. The system may also use an iterative training algorithm to re-train with additional data.

The operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices. The AI or ML may store data in a decision tree in a novel way.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an ANDROID® device, an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet may be contemplated.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over technology by using a decentralized database and improved processing environments. In particular, the blockchain implementation improves computer performance by, for example, leveraging decentralized resources (e.g., lower latency). The distributed computational resources improve computer performance by, for example, reducing processing times. Furthermore, the distributed computational resources improve computer performance by improving security using, for example, cryptographic protocols.

In various embodiments, the system may send a signal to an accounting system, procurement system and/or inventory system to allow the user to obtain goods or services from a supplier associated with the items. The system may generate an authorized purchase message to send to a portal (e.g., a kiosk, a gate, a locker, an area, etc.). The portal may activate a motor, a door and/or a lever to allow the provider access to retrieve a purchased item and/or leave an area with the purchased item. The authorized purchase message may include the purchase order number, purchase order data, transaction number, the timestamp, the currency type, the amount, the transaction code, the transaction type, the description, provider ID, supplier ID, product IDs, a portal ID, and/or the like. The system may then transmit the authorized purchase message to the portal. The portal may verify certain data in the authorized purchase message, and based on the verification, the portal may grant the customer access to the purchased item. In various embodiments, access to the purchased item may include opening a door, lifting a gate, providing access to an area, displaying a product, rotating a platform, dispensing a product and/or causing other mechanical or physical access that allows the user to take the purchased item and/or leave the inventory area.

For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise, as set forth in Slip op. at 8-9 (Fed. Cir. Oct. 19, 2023) (citing Baldwin Graphic Sys., Inc. v. Siebert, Inc., 512 F.3d 1338, 1342-43 (Fed. Cir. 2008)). For example, the description or claims may refer to a processor for convenience, but the invention and claim scope contemplates that the processor may be multiple processors. The multiple processors may handle separate tasks or combine to handle certain tasks. Although specific advantages have been enumerated herein, various embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 ® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through various data association techniques. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with various embodiments, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The above description of specific embodiments has been given by way of example. From the disclosure given, those skilled in the art will not only understand the general inventive concepts and attendant advantages, but will also find apparent various changes and modifications to the structures and methods disclosed. For example, alternative methods and/or systems with additional or alternative components may be utilized to rank one or more search results for products based on price incentive structures associated with the products. It is sought, therefore, to cover all such changes and modifications as fall within the spirit and scope of the general inventive concepts, as defined by the appended claims, and equivalents thereof.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A method comprising:
receiving, by one or more processors, a search query for one or more products;
determining, by the one or more processors, a query result set of a plurality of result products, in response to the search query;
determining, by the one or more processors, a subset of the plurality of result products that satisfy at least one of environmental, social, governance (ESG) factors or diversity factors;
ranking, by the one or more processors, the subset of the plurality of result products to create a ranked query result, based at least in part on a weighting of the at least one of the ESG factors or the diversity factors; and
providing, by the one or more processors, the ranked query result set to the user.

2. The method of claim 1, further comprising determining, by the one or more processors, the weighting of the at least one of the ESG factors or the diversity factors.

3. The method of claim 1, wherein the ranking the subset of the plurality of result products to create the ranked query result is further based at least in part on a multi-factor weighting of at least one of the ESG factors, the diversity factors or the price incentive factors.

4. The method of claim 1, further comprising associating, by the one or more processors, each of the plurality of result products with at least one of the ESG factors, the diversity factors or the price incentive factors.

5. The method of claim 1, wherein the determining the subset of the plurality of result products that satisfy at least one of the ESG factors or the diversity factors includes satisfying at least one of a threshold of the ESG factors or a threshold of the diversity factors.

6. The method of claim 1, wherein the ESG factors includes at least one of environmental factors, social factors or governance factors.

7. The method of claim 1, wherein the determining the subset of the plurality of result products further includes determining the subset of the plurality of result products that satisfy price incentive factors.

8. The method claim 7, wherein the price incentive factors include at least one of a total to fulfill the price incentive or a price incentive amount.

9. The method of claim 7, wherein the ranking is further based on price incentive factors, and wherein the price incentive factors are based on a number of the one or more products that have been purchased to date, a value of the one or more products that have been purchased to date or a total to fulfill a price incentive threshold value for the one or more products.

10. The method of claim 7, wherein the ranking is further based on price incentive factors, and wherein a first price incentive eligible product is more indicative of importance than a second price incentive eligible product when the number of the first price incentive eligible products sold is closer to fulfillment than the second price incentive eligible product.

11. The method of claim 7, wherein the ranking is further based on price incentive factors, and wherein a ranking of a price incentive eligible product is more indicative of importance than a second product of the query result when the second product is not associated with a price incentive structure.

12. The method of claim 7, wherein the ranking is further based on price incentive factors, and wherein the price incentive factors include a tiered price incentive structure, wherein the tiered price incentive structure includes two or more tiers, and wherein each of the tiers includes a total to fulfill the tier and a tier price incentive amount.

13. The method of claim 7, wherein the ranking is further based on price incentive factors, and wherein the ranking is associated with a tiered price incentive that is determined based on an amount of the price incentive eligible product to be sold to satisfy a tier.

14. The method of claim 7, wherein the ranking is further based on price incentive factors, and wherein the ranking is based on at least one of a number or value of the products that have been purchased to date and total to fulfill the price incentive threshold value and further wherein at least one of the price incentive structures is a tiered price incentive structure, wherein the tiered price incentive structure includes two or more tiers, and wherein each of the tiers includes a total to fulfill the tier and a tier price incentive amount.

15. The method of claim 7, wherein the price incentive factors comprise data that alters a purchase price of a product based on at least one of a tier, a volume, a rebate or an administrative fee.

16. The method of claim 1, further comprising replacing, by the one or more processors, one or more of the result products in the subset of the plurality of result products with one or more substitute products.

17. The method of claim 1, wherein the ranking is further based on a fulfillment score, wherein the fulfillment score is determined based on a price incentive structure for one or more of the result products.

18. The method of claim 1, further comprising receiving, by the one or more processors, from a user at least one of the ESG factors or the diversity factors.

19. An article of manufacture including one or more non-transitory, tangible computer readable storage mediums having instructions stored thereon that, in response to execution by one or more processors, cause the one or more processors to perform operations comprising:
receiving, by the one or more processors, a search query for one or more products;
determining, by the one or more processors, a query result set of a plurality of result products, in response to the search query;
determining, by the one or more processors, a subset of the plurality of result products that satisfy at least one of environmental, social, governance (ESG) factors or diversity factors;
ranking, by the one or more processors, the subset of the plurality of result products to create a ranked query result, based at least in part on a weighting of the at least one of the ESG factors or the diversity factors; and
providing, by the one or more processors, the ranked query result set to the user.

20. A system comprising:
one or more processors; and
one or more tangible, non-transitory memories configured to communicate with the one or more processors,
the one or more tangible, non-transitory memories having instructions stored thereon that, in response to execution by the one or more processors, cause the one or more processors to perform operations comprising:
receiving, by the one or more processors, a search query for one or more products;
determining, by the one or more processors, a query result set of a plurality of result products, in response to the search query;
determining, by the one or more processors, a subset of the plurality of result products that satisfy at least one of environmental, social, governance (ESG) factors or diversity factors;
ranking, by the one or more processors, the subset of the plurality of result products to create a ranked query result, based at least in part on a weighting of the at least one of the ESG factors or the diversity factors; and
providing, by the one or more processors, the ranked query result set to the user.
